(19) United States
(12) Patent Application Publication
(10) Pub. No.: US 2018/0079421 A1
(43) Pub. Date: Mar. 22, 2018

(54) Vehicle Control Method, Control Device, In-Vehicle System, and Vehicle Control System

(71) Applicant: BOE Technology Group Co., Ltd., Beijing (CN)

(72) Inventors: Shuo Chen, Beijing (CN); Weiqing Guo, Beijing (CN)

(73) Assignee: BOE Technology Group Co., Ltd., Beijing (CN)

(21) Appl. No.: 15/535,910

(22) PCT Filed: Dec. 5, 2016
(86) PCT No.: PCT/CN2016/108565

§ 371 Date: Jun. 14, 2017

(30) Foreign Application Priority Data
Mar. 11, 2016 (CN) 201610139680.4

(51) Int. Cl. B60W 30/192; B60W 30/18; G08G 1/0962

(52) U.S. Cl. CPC B60W 30/192; B60W 30/18018; G08G 1/0962; B60W 2710/06; B60W 2520/04; B60W 2550/20; B60Y 2300/192

(57) ABSTRACT

A vehicle control method includes: obtaining a current location of a vehicle; judging whether the vehicle is in a temporary waiting state or not according to the current location; determining to turn on or off an automatic start/stop function of the vehicle based on the judgment. The control method can distinguish whether the vehicle is waiting for a traffic light or is in a congestion situation, and choose to turn on the automatic start/stop function according to a current road condition, so as to make the automatic start/stop function of the vehicle to be more real-time and accurate, and maximize the reduction of fuel consumption and exhaust emission. A vehicle control device, an in-vehicle system and a vehicle control system are further provided.

### TECHNICAL FIELD

At least an embodiment of the present disclosure relates to a vehicle control method, a control device, an in-vehicle system, and a vehicle control system.

### BACKGROUND

Currently, an automatic start/stop function of a vehicle is widely used in automatic transmission vehicles, for the vehicle has the automatic start/stop function, in the case that the automatic start/stop function is turned on, in the scene of the traffic jam and waiting for a red light, an engine of the vehicle automatically stalls in the case that the state of the vehicle is changing from a moving state to a brake stop state, and then the engine is reignited when the vehicle is re-started, so as to reduce unnecessary fuel consumption and reduce exhaust emissions.

However, in the case that the level of the road congestion is not serious, the vehicle is in the repeated switching state of stopping, moving, braking and starting, or during waiting for the traffic light and the traffic light being about to turn on, the vehicle is in the repeated switching state of stopping, moving, braking and starting; if the automatic start/stop function being turned on in the above scene, in a short time, the engine repeatedly stalls and ignites automatically, which is not only harmful to the life of the engine, but also not in favor of saving fuel and environmental protection.

### SUMMARY

According to an embodiment of the present disclosure, a vehicle control method is provided, and the method comprises: judging whether a vehicle is in a temporary waiting state or not; in the case that a judgment result is that the vehicle is in the temporary waiting state, turning off an automatic start/stop function of the vehicle.

Optionally, judging whether the vehicle is in the temporary waiting state or not comprises: judging whether the vehicle is in the temporary waiting state or not at least according to a current brake frequency of the vehicle.

Optionally, judging whether the vehicle is in the temporary waiting state or not according to the current brake frequency of the vehicle comprises: in the case that the current brake frequency of the vehicle is greater than a brake frequency threshold, determining that the vehicle is in the temporary waiting state, otherwise, determining that the vehicle is not in the temporary waiting state.

Optionally, judging whether the vehicle is in the temporary waiting state or not at least according to the current brake frequency of the vehicle comprises: judging whether the vehicle is in the temporary waiting state or not according to the current brake frequency and a current location of the vehicle.

Optionally, judging whether the vehicle is in the temporary waiting state or not according to the current brake frequency and the current location of the vehicle comprises: in the case that the current brake frequency of the vehicle is greater than a brake frequency threshold and the vehicle dose not wait for a traffic light, determining that the vehicle is in the temporary waiting state, otherwise, determining that the vehicle is not in the temporary waiting state.

Optionally, judging whether the vehicle is in the temporary waiting state or not comprises: judging whether the vehicle is in the temporary waiting state or not according to the current location of the vehicle.

Optionally, judging whether the vehicle is in the temporary waiting state or not according to the current location of the vehicle comprises: obtaining real-time traffic information corresponding to the current location based on the current location; in the case that the current location indicated by the real-time traffic information is a location of waiting for the traffic light, determining a waiting time period needed by the vehicle to wait for the traffic light from the current time, and in the case that the waiting time period is less than a threshold time, determining that the vehicle is in the temporary waiting state, otherwise, determining that the vehicle is not in the temporary waiting state.

Optionally, in the case that the vehicle is not in the temporary waiting state, the method further comprises: turning on an automatic start/stop function of the vehicle.

Optionally, before turning off the automatic start/stop function of the vehicle, the method further comprises: determining that the automatic start/stop function of the vehicle is turned on or off through an automatic mode rather than a manual mode.

According to an embodiment of the present disclosure, an in-vehicle system is provided, and the in-vehicle system comprises: a controller and a processor, wherein the processor is configured to judge whether the vehicle is in a temporary waiting state or not; and the controller is configured to turn off an automatic start/stop function of the in-vehicle system in the case that the processor determines that the vehicle is in the temporary waiting state.

Optionally, the in-vehicle system further comprises: a brake information obtaining device configured to obtain a current brake frequency of the vehicle and provide the brake frequency to the processor; and the processor is configured to determine whether the vehicle is in the temporary waiting state or not at least according to the brake frequency.

Optionally, the in-vehicle system further comprises: a positioning device configured to obtain a current location of the vehicle and provide the current location to the processor; and the processor is configured to determine whether the vehicle is in the temporary waiting state or not according to the brake frequency and the current location.

Optionally, the in-vehicle system further comprises: a positioning device configured to obtain a current location of the vehicle and provide the current location to the processor; and the processor is configured to determine whether the vehicle is in the temporary waiting state or not according to the current location.

According to an embodiment of the present disclosure, a vehicle control device is provided, and the vehicle control device comprises: a judgment unit configured to judge whether a vehicle is in a temporary waiting state or not; and a control unit configured to turn off an automatic start/stop function of the vehicle in the case that a judgment result is that the vehicle is in the temporary waiting state.

Optionally, the judgment unit is further configured to judge whether the vehicle is in the temporary waiting state or not at least according to the current brake frequency of the vehicle.

Optionally, the judgment unit is further configured to determine that the vehicle is in the temporary waiting state in the case that the current brake frequency of the vehicle is greater than a brake frequency threshold, otherwise, to determine that the vehicle is not in the temporary waiting state.

Optionally, the judgment unit is further configured to judge whether the vehicle is in the temporary waiting state or not according to the current brake frequency and the current location of the vehicle.

Optionally, the judgment unit is further configured to determine that the vehicle is in the temporary waiting state in the case that the current brake frequency of the vehicle is greater than the brake frequency threshold and the vehicle dose not wait for a traffic light, otherwise, to determine that the vehicle is not in the temporary waiting state.

Optionally, the judgment unit is further configured to judge whether the vehicle is in the temporary waiting state or not according to the current location of the vehicle.

Optionally, the judgment unit comprises: an obtaining unit configured to obtain real-time traffic information corresponding to the current location based on the current location; a determining unit configured to determine a waiting time period needed by the vehicle to wait for the traffic light from the current time in the case that the real-time traffic information indicates that the current location is a location of waiting for the traffic light, and in the case that the waiting time period is less than a threshold time, to determine that the vehicle is in the temporary waiting state, otherwise, to determine that the vehicle is not in the temporary waiting state.

Optionally, the vehicle control device further comprises: a start unit. In the case that the vehicle is not in the temporary waiting state, the start unit turns on an automatic start/stop function of the vehicle.

Optionally, the vehicle control device further comprises: a start mode determining unit. Before turning off the automatic start/stop function of the vehicle, the start mode determining unit determines that the automatic start/stop function of the vehicle is turned on or off through an automatic mode rather than a manual mode.

According to an embodiment of the present disclosure, a vehicle control system is provided, and comprises a traffic information system and the in-vehicle system according to any one of the above in-vehicle systems, wherein the traffic information system sends traffic information to the in-vehicle system, and the in-vehicle system determines to turn-on or off an automatic start/stop function of the vehicle according to the traffic information.

Optionally, the in-vehicle system is connected with the traffic information system through a network, and the traffic information system sends the traffic information to the in-vehicle system through the network.

Optionally, the network comprises at least one of a wired communication network or a wireless communication network.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic flow chart of a vehicle control method according to at least one embodiment of the present disclosure;

FIG. 2 is a schematic frame chart of a vehicle control device according to at least one embodiment of the present disclosure;

FIG. 3 is a structural schematic view of an in-vehicle system according to at least one embodiment of the present disclosure;

FIG. 4 is a structural schematic view of a vehicle control system according to at least one embodiment of the present disclosure.

### REFERENCE NUMERALS

200: vehicle control device, 210: judgment unit, 220: control unit, 230: start unit, 240: start mode determining unit, 300: in-vehicle system, 310: controller, 320: processor, 330: obtaining device, 340: positioning device, 350: communication unit; 400: vehicle control system, 410: in-vehicle system, 420: traffic information system.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “include,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

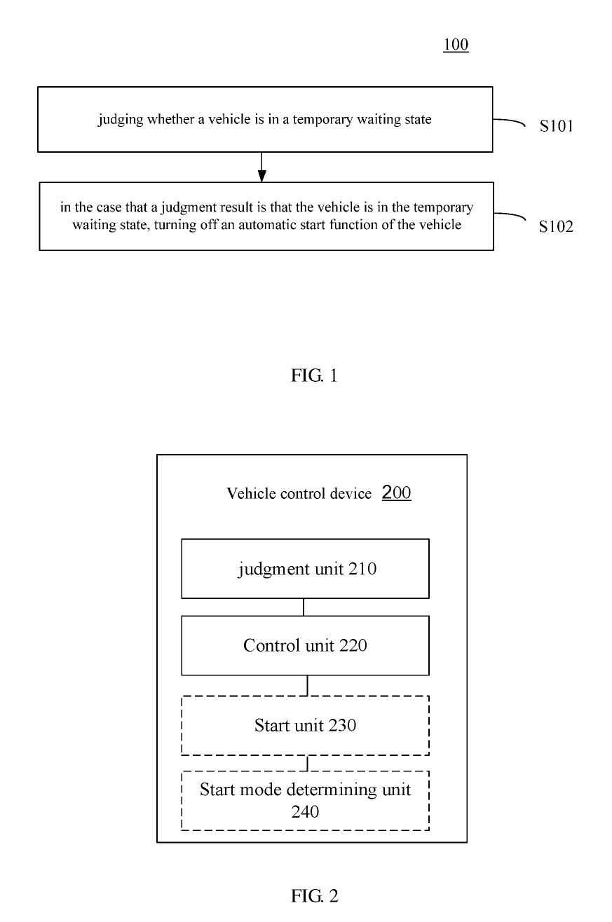

FIG. 1 illustrates a flow chart of a vehicle control method according to first embodiment of the present disclosure, refer to FIG. 1, the vehicle control method 100 of the first embodiment of the present disclosure will be introduced below. The vehicle control method in the embodiment of the present disclosure can be applied to a variety of motor vehicles, and the motor vehicles at least comprise a drive system (such as an engine or an electric motor, a clutch and the like), a processor, a controller and the like, so as to control the operation of the vehicle.

In addition, in the embodiment of the present disclosure, after the vehicle turns on an automatic start/stop function, the engine can be stopped automatically in a brake static state, and the engine can be started during releasing the brake, so as to start the vehicle to move. After the vehicle turns off the automatic start/stop function, the above mentioned function is turned off.

Refer to FIG. 1, in step S101 of the vehicle control method 100, judging whether the vehicle is in a temporary waiting state or not. In the embodiment of the present disclosure, the temporary waiting state is that a time of the vehicle being in a static wait state is relatively short.

In step S102, in the case that a judgment result is that the vehicle is in the temporary waiting state, turning off an automatic start/stop function of the vehicle.

According to an example of the present disclosure, it can be judged whether the vehicle is in the temporary waiting state or not at least according to a current brake frequency of the vehicle. In the case that the brake frequency is high, it is determined that the vehicle is in the temporary waiting state, otherwise, in the case that the brake frequency is low, it is determined that the vehicle is not in the temporary waiting state.

For example, whether the brake frequency is high or not can be judged through a brake frequency threshold. In the case that the current brake frequency of the vehicle is greater than the brake frequency threshold, it is determined that the vehicle is in the temporary waiting state, otherwise, it is determined that the vehicle is not in the temporary waiting state. For example, in the case that the vehicle is in a congestion state, the vehicle tends to repeatedly start and brake, at this time, the brake frequency parameters of the vehicle can be determined. For example, the brake frequency parameters can be calculated by calculating the number of brake in a constant time. For example, the number of brake can be obtained within 1, 3, 5, or 10 minutes before the current time; in the case that the brake frequency parameter is determined to be greater than or equal to a predetermined frequency threshold, for example, in the case that the brake frequency is greater than or equal to 4 times, it means that the vehicle repeatedly stops and moves but still can move, and the road condition is not very congested, therefore it can be determined that the vehicle is in the temporary waiting state. At this time, the automatic start/stop function of the vehicle can be turned off, so as to avoid an adverse effect of repeatedly turning on and off the engine in a short time on the engine life.

In addition, if the brake frequency parameter is determined to be less than the predetermined frequency threshold, it can imply that the road condition is very congested, and the vehicle is difficult to move. For example, in the case that the brake frequency is less than 4 times, it generally can be determined that the current road condition is in a very congested state, and it can be determined that the vehicle is not in the temporary waiting state at this time. In this case, the automatic start/stop function of the vehicle can be turned on, and the engine is turned off in the case that the vehicle is in a brake static state, so as to save energy, reduce exhaust emissions, and the like. The engine is started again in the case that the brake is released.

According to another example of the present disclosure, it can be further judged whether the vehicle is in the temporary waiting state or not according to the current brake frequency and a current location of the vehicle. In the case that the current frequency is determined to be greater than the brake frequency threshold, the current location information of the vehicle can be further obtained, and it is determined whether the vehicle is in a special road condition environment rather than simply in a traffic jam state according to the current location information. For example, the location information of the vehicle, such as the current geographic coordinate, the traveling direction, the traveling road and/or the front intersection which the vehicle is passing or will pass, can be obtained. For example, a positioning device (for example, a GPS positioning device, a Beidou positioning device, a mobile phone base station positioning device, or any combination of these devices) can be installed in the vehicle, so as to obtain the geographical location information of the vehicle in real time (for example, the delay is less than 5 seconds, preferably less than 3 seconds).

For example, it can be judged whether the vehicle is waiting for a traffic light according to the obtained location information. In the case that the current brake frequency of the vehicle is greater than the brake frequency threshold and the vehicle dose not wait for the traffic light, it is determined that the vehicle is in the temporary waiting state, otherwise, it is determined that the vehicle is not in the temporary waiting state.

According to an example of the present disclosure, firstly, real-time traffic information corresponding to the current location is obtained based on the current location, and then it is further judged whether the vehicle is waiting for the traffic light or not based on the real-time traffic information. If the vehicle does not wait for the traffic light, combined with the information that the current brake frequency is greater than the brake frequency threshold, it can be determined that the current vehicle is in a repeatedly moving and stopping state without waiting for the traffic light, furthermore it can be determined that the vehicle is in the temporary waiting state, and the automatic start and stop system can be turned off at this time. According to the real-time traffic information corresponding to the obtained location information, if it is determined that the vehicle is waiting for the traffic light, then the vehicle is likely to constantly brake in the state of waiting for the red light, so as to lead to the result that the brake frequency is greater than the predetermined brake frequency threshold, it can be determined that the vehicle is not necessarily in the congestion state at this time, therefore, it is determined that the vehicle is not in the temporary waiting state. Then the automatic start and stop system can be turned on.

According to an embodiment of the present disclosure, it can be also judged whether the vehicle is in the temporary waiting state or not according to the current location of the vehicle. Optionally, as mentioned above, the location information, such as the current geographic coordinate of the vehicle, the vehicle traveling direction, the vehicle traveling road and/or the front intersection which the vehicle is passing or will pass, can be obtained. For example, the positioning device (for example, the GPS positioning device, the Beidou positioning device, the mobile phone base station positioning device, or any combination of these devices) can be installed in the vehicle, so as to obtain the geographical location information of the vehicle in real time (for example, the delay is less than 5 seconds, preferably less than 3 seconds).

Optionally, an in-vehicle system of the vehicle further can be connected with a traffic information system through a wired or a wireless communication network, to obtain traffic information of the current location of the vehicle. For example, the current location information of the vehicle can be sent to the above mentioned traffic information system through a network. The traffic information system comprises real-time traffic information of a city or a region. For example, the real-time traffic information comprises road condition information and traffic control information of each intersection in the region, traffic light information of all intersection in the region, and the like. The traffic light information, for example, comprises: the intersection where the traffic light is located, the location and the number of the traffic light, the current color of the traffic light, the remaining time of the current traffic light with the above current color, and the like. The vehicle sends the obtained current location to the above mentioned traffic information system through the network, and requests to return the real-time traffic information corresponding to the current location. Alternatively, the vehicle can also be always kept in synchronized state with the traffic information of the traffic information system. The traffic information system can send all the real-time traffic information to the vehicle through the network and regularly update the information, so that the real-time traffic information in the vehicle is kept synchronized with the information of the traffic information system. In this way, the vehicle can obtain the real-time traffic information corresponding to the current location based on the current location information, and therefore can judge whether the vehicle is waiting for the traffic light or not and the waiting time period and other information according to the real-time traffic information.

According to an example of the present disclosure, the real-time traffic information corresponding to the current location can be obtained based on the current location. The real-time traffic information can be whether the vehicle is waiting for the traffic light or not (such as a red light or a yellow light). In the case that the real-time traffic information indicates that the current location is a location of waiting for the traffic light, the vehicle can further determine a waiting time period needed by the vehicle to wait for the traffic light from the current time, and further determine to turn on or turn off the automatic start/stop function according to the waiting time period. In the case that the waiting time period is less than a threshold time, it is determined that the vehicle is in the temporary waiting state, otherwise, it is determined that the vehicle is not in the temporary waiting state.

For example, while the vehicle obtains the real-time traffic information, in addition to obtaining the color of the traffic light of the front intersection, the remaining time of the current traffic light with the above color is further obtained. For example, in the case that the remaining time that the vehicle waits for the traffic light is less than 15 seconds, it can be determined that the vehicle is in the temporary waiting state, it means that the vehicle can be going to moving again, at this time the automatic start/stop function is turned off, and there is no need to stop the engine, so as to intelligently control the automatic start and stop system, which not only can save energy and protect environment, but also can prolong the life of the engine. On the contrary, in the case that the waiting time period is greater than or equal to the predetermined time threshold, it is determined that the vehicle is not in the temporary waiting state, and the automatic start/stop function of the vehicle can be turned on. For example, in the case that the time of waiting for the red light is greater than or equal to 15 seconds, the automatic start/stop function of the vehicle can be turned on at this time. In this case, under the condition that the remaining time of waiting for the red light is greater than or equal to 15 seconds, the automatic start and stop system will automatically turn off the engine in the case that the vehicle is in the brake state and the speed of the vehicle is zero; and in the case that the vehicle is in the brake release state, the vehicle restarts the engine, which can effectively save energy, reduce pollution, and retard engine abrasion and aging, and the like.

In addition, according to an example of the present disclosure, before turning off the automatic start/stop function of the vehicle, it further can be determined that the automatic start/stop function of the vehicle is turned on or turned off through an automatic mode rather than a manual mode.

For example, in the case that a user does not need the automatic start/stop function, the user tends to manually turn off the function. In the case that the user gets used to use the automatic start and stop system, the user also tends manually turn on the function. Therefore, in order to adapt to the using habit of the user, according to an example of the present disclosure, before turning off the automatic start/stop function of the vehicle, it can be further judged whether the automatic start/stop function of the vehicle is turned on or turned off through the automatic mode rather than the manual mode. In the case that it is determined that the function is turned on or turned off through the automatic mode, the step of turning off the automatic start/stop function in the above mentioned embodiment can be carried out. In the case that it is determined that the function is turned on or turned off through the manual mode, the step of turning off the automatic start/stop function in the above mentioned embodiment is not carried out based on the principle of the manual mode take precedence.

For example, after determining that the brake frequency parameter is greater than or equal to the predetermined frequency threshold, it is further determined whether the automatic start/stop function is in the state of manually turning off or manually turning on. In the case that the automatic start/stop function of the vehicle is in the state of manually turning off, the automatic start/stop function will be not turned on again. However, in the case that the automatic start/stop function of the vehicle is in the state of manually turning on, the state of the automatic start/stop function being turned on will be still kept based on the principle of the user manually setting take precedence.

Certainly, those skilled in the art should understood that the step for determining the state of manually turning on and off can also be performed before judging whether the vehicle is waiting for the traffic light or not, and can also be performed before obtaining the current location of the vehicle, in the case that it is determined that the user has manually turned off the automatic start/stop function, there is no need to obtain the location or wait for the judgment result, so as to save resources of the processor.

In the embodiment of the present disclosure, by determining whether the vehicle is in the temporary waiting state or not, so that in the case that the vehicle is in the temporary waiting state, for example, in the case that the vehicle is waiting for the traffic light or the congestion level is not serious, the automatic start and stop system is turned off, so as to prevent the engine from repeatedly stall and ignite automatically in a short time, and therefore prevent the reduction of the life of the engine; in addition, it is also in favor of saving fuel and environmental protection. In the case that the vehicle is not in the temporary waiting state, the automatic start and stop system is turned-on, and in the case that the vehicle is in the brake state and the speed of the vehicle is zero, the engine will be automatically turned off, so as to save energy, reduce pollution, and retard engine abrasion and aging, and the like.

What are described above is the vehicle control method according to the first embodiment of the present disclosure, a vehicle control device according to second embodiment of the present disclosure will be further introduced below, the vehicle control device is a device corresponding to the vehicle control method, in order to make the specification to be concise, the following is only a brief introduction.

FIG. 2 illustrates a schematic frame chart of the vehicle control device according to the second embodiment of the present disclosure. Refer to FIG. 2, the vehicle control device 200 comprises: a judgment unit 210 and a control unit 220.

The judgment unit is configured to determine whether a vehicle is in a temporary waiting state or not.

The control unit is configured to turn off an automatic start/stop function of the vehicle in the case that a judgment result is that the vehicle is in the temporary waiting state.

Optionally, the judgment unit is further configured to judge whether the vehicle is in the temporary waiting state or not at least according to the current brake frequency of the vehicle.

Optionally, the judgment unit is further configured to determine that the vehicle is in the temporary waiting state in the case that the current brake frequency of the vehicle is greater than a brake frequency threshold, otherwise, to determine that the vehicle is not in the temporary waiting state.

Optionally, the judgment unit is further configured to judge whether the vehicle is in the temporary waiting state or not according to the current brake frequency and the current location of the vehicle.

Optionally, the judgment unit is further configured to determine that the vehicle is in the temporary waiting state in the case that the current brake frequency of the vehicle is greater than the brake frequency threshold and the vehicle dose not wait for a traffic light, otherwise, to determine that the vehicle is not in the temporary waiting state.

Optionally, the judgment unit is further configured to judge whether the vehicle is in the temporary waiting state or not according to the current location of the vehicle.

Optionally, the judgment unit comprises: an obtaining unit configured to obtain real-time traffic information corresponding to the current location based on the current location; a determining unit configured to determine a waiting time period needed by the vehicle to wait for the traffic light from the current time in the case that the real-time traffic information indicates that the current location is a location of waiting for the traffic light, and in the case that the waiting time period is less than a threshold time, to determine that the vehicle is in the temporary waiting state, otherwise, to determine that the vehicle is not in the temporary waiting state.

Optionally, the vehicle control device further comprises: a start unit 230. In the case that the vehicle is not in the temporary waiting state, the start unit turns on the automatic start/stop function of the vehicle.

Optionally, the vehicle control device further comprises: a start mode determining unit 240. Before turning off the automatic start/stop function of the vehicle, the start mode determining unit determines that the automatic start/stop function of the vehicle is turned on or turned off through an automatic mode rather than a manual mode.

The vehicle control device of the embodiment of the present disclosure can distinguish whether the vehicle is in the temporary waiting state or not, and intelligently determine whether to turn on or off the automatic start/stop function according to the current state, so as to make the automatic start/stop function be more real-time and intelligent, and maximize the reduction of fuel consumption and exhaust emission.

What are described above is the vehicle control method according to the first embodiment of the present disclosure and the vehicle control device, which is correspond to the vehicle control method, according to the second embodiment of the present disclosure. An in-vehicle system according to third embodiment of the present disclosure will be further introduced below. The in-vehicle system is used to perform the vehicle control method of the first embodiment of the present disclosure, the content which is the same with the method only will be introduced briefly, and the concrete description can refer to the first embodiment of the present disclosure.

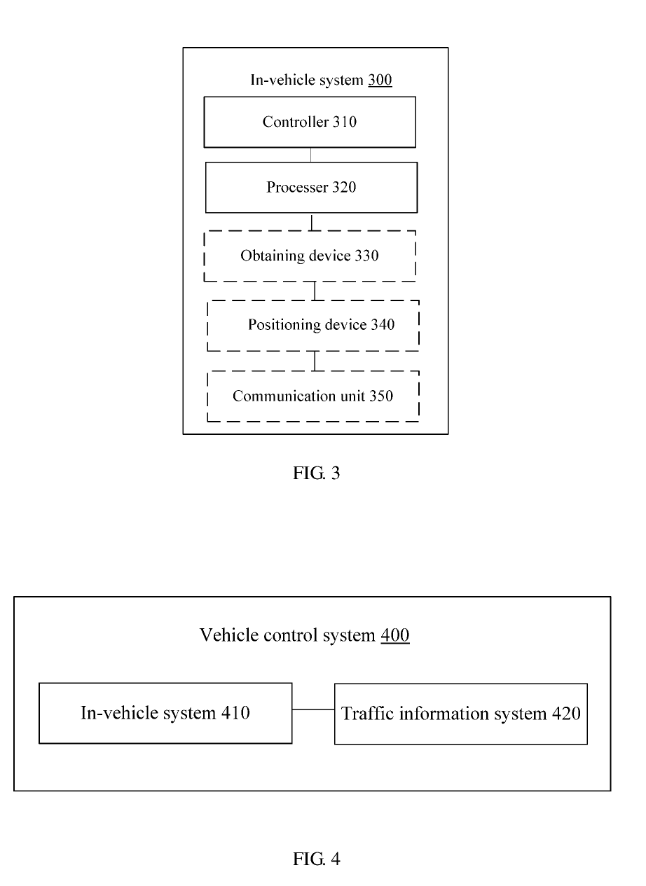

FIG. 3 illustrates a schematic frame chart of the in-vehicle system according to third embodiment of the present disclosure. Refer to FIG. 3, the in-vehicle system 300 comprises: a controller 310 and a processor 320.The processor 320 is configured to judge whether the vehicle is in a temporary waiting state or not. The controller 310 is configured to turn off an automatic start/stop function in the case that the processor determines that the vehicle is in the temporary waiting state.

Optionally, the in-vehicle system further comprises a brake information obtaining device 330, which is configured to obtain a current brake frequency of the vehicle and provide the brake frequency to the processor 320; and the processor 320 is configured to determine whether the vehicle is in the temporary waiting state or not at least according to the brake frequency.

Optionally, the in-vehicle system further comprises a positioning device 340, which is configured to obtain a current location of the vehicle and provide the current location to the processor 320; and the processor 320 is configured to determine whether the vehicle is in the temporary waiting state or not according to the brake frequency and the current location.

Optionally, the in-vehicle system further comprises a positioning device 340, which is configured to obtain a current location of the vehicle and provide the current location to the processor 320; and the processor 320 is configured to determine whether the vehicle is in the temporary waiting state or not according to the current location.

The positioning device 340, for example, can be a global positioning system (GPS) device, a Beidou positioning device, a mobile phone base station positioning device, or any combination of the above positioning devices, that is, a device which can obtain the current location of the vehicle. The positioning device 340 can obtain a current geographic coordinate information of the vehicle, and also can obtain the location information, such as the vehicle traveling direction, the vehicle traveling road and the front intersection which the vehicle is passing or will pass, according to the geographic coordinate information and/or the moving displacement of the vehicle. For example, the in-vehicle system 300 can comprises a communication unit 350, and the communication unit 350 is configured to obtain real-time traffic information corresponding to the current location based on the current location. The communication unit 350, for example, comprises a receiver, a transmitter, a network communication interface, an antenna and the like. With the communication unit 350, the in-vehicle system 300 can send the current geographic coordinate information of the vehicle obtained by the positioning device 340 to a traffic information system connected with the in-vehicle system through the network, and the traffic information system sends back the traffic information of the current location of the vehicle according to the current geographic coordinate information of the vehicle. For example, the traffic information comprises road condition information, traffic control information, traffic light information of all the intersection located at the above location and the neighborhood location, and the like. The traffic light information, for example, comprises: the intersection where the traffic light is located, the direction and the number of the traffic light, the color of the traffic light, the remaining time of the current traffic light with the above color, and the like. The above mentioned traffic information is received by the communication unit 350 of the vehicle, and is feed back to the processor 320 of the in-vehicle system of the vehicle.

The processor 320 is configured to judge whether the vehicle is in the temporary waiting state or not according to the current location. For example, the processor 320 judges whether the vehicle is in a congestion state, or judges whether the vehicle is in awaiting for the traffic light state or not based on the real-time traffic information. Base on the judgment result, it is determined to start or stop the automatic start/stop function of the vehicle, and a start signal of starting the automatic start/stop function or a stop signal of stopping the automatic start/stop function is sent to the controller 310.

The controller 310 is configured to receive the start signal or the stop signal of the automatic start/stop function sent by the processor 320, and to start the engine of the vehicle according to the start signal. For example, in the case that the controller 310 receives the start signal of the automatic start/stop function sent by the processor 320, the automatic start/stop function of the vehicle is turned on, and in the case that the controller 310 receives the stop signal of stopping the automatic start/stop function sent by the processor 320, the automatic start/stop function of the vehicle is turned off. And in the case that the automatic start/stop function is turned on and the signal that the vehicle is in the brake static state is obtained, the controller 310 further controls to turn off the engine. In the case that the automatic start/stop function is turned on and the signal that the brake of the vehicle is released is obtained, the controller 310 further controls to turn on the engine. And in the case that the automatic start/stop function is turned off, even if the signal that the vehicle is in the brake static state is obtained, the processor 320 will not send the signal of starting or stopping the automatic start/stop function to the controller 310, such that the controller 310 will not turn on or off the engine, so that the engine can be intelligently controlled to turn on or off to ensure the life of the engine.

The in-vehicle system of the embodiment of the present disclosure can selectively turn on or off the automatic start/stop function according to the obtained vehicle state, so as to maximize the reduction of the fuel consumption and exhaust emission.

What are described above is the in-vehicle system according to the third embodiment of the present disclosure, a vehicle control system according to fourth embodiment of the present disclosure will be further introduced below. FIG. 4 illustrates the vehicle control system 400 according to the fourth embodiment of the present disclosure, as illustrated in FIG. 4, the vehicle control system 400 comprises the in-vehicle system 410, and further comprises a traffic information system 420. The in-vehicle system 410 is an in-vehicle system described in the third embodiment, and the concrete structure and function can refer to the third embodiment of the present disclosure, no further description will be given herein.

In the vehicle control system 400, the traffic information system 420 sends the traffic information to the in-vehicle system 410, and the traffic information system 420 comprises real-time traffic information of a city or a region. For example, the real-time traffic information comprises road condition information and traffic control information of each intersection in the region, traffic light information of all intersection in the region, and the like. The traffic light information, for example, comprises: the intersection where the traffic light is located, the direction and the number of the traffic light, the color of the traffic light, the remaining time of the current traffic light with the above color, and the like.

The in-vehicle system 410 determines to turn on or off the automatic start/stop function of the vehicle according to the traffic information. The in-vehicle system 410 can be connected with the traffic information system 420 through a wired communication network or a wireless communication network (such as through the Internet, cellular networks, and the like).The traffic information system 420 sends the traffic information to the in-vehicle system 410 through the network.

The vehicle control system of the embodiment of the present disclosure can control the vehicle according to the real-time traffic information, so as to determine whether to turn on the automatic start/stop function of the vehicle or not, so as to make the automatic start/stop function be more real-time and intelligent.

What are described above is related to the concrete embodiments of the present disclosure only and not limitative to the scope of the disclosure, within the disclosed technical scope of the disclosure, any modification and replacement, which can be easily envisaged by any skilled who is familiar with the technical field in the art, should be within the scope of the disclosure. Therefore, the scopes of the disclosure are defined by the accompanying claims.

The application claims priority to the Chinese patent application No. 201610139680.4, filed Mar. 11, 2016, the entire disclosure of which is incorporated herein by reference as part of the present application.

1. A vehicle control method, comprising:
judging whether a vehicle is in a temporary waiting state or not; and
in the case that a judgment result is that the vehicle is in the temporary waiting state, turning off an automatic start/stop function of the vehicle.

2. The method according to claim 1, wherein judging whether the vehicle is in the temporary waiting state or not comprises:
judging whether the vehicle is in the temporary waiting state or not at least according to a current brake frequency of the vehicle.

3. The method according to claim 2, wherein judging whether the vehicle is in the temporary waiting state or not according to the current brake frequency of the vehicle comprises:
in a case that the current brake frequency of the vehicle is greater than a brake frequency threshold, determining that the vehicle is in the temporary waiting state, otherwise, determining that the vehicle is not in the temporary waiting state.

4. The method according to claim 2, wherein judging whether the vehicle is in the temporary waiting state or not at least according to the current brake frequency of the vehicle comprises:
judging whether the vehicle is in the temporary waiting state or not according to the current brake frequency and a current location of the vehicle.

5. The method according to claim 4, wherein judging whether the vehicle is in the temporary waiting state or not according to the current brake frequency and the current location of the vehicle comprises:
in a case that the current brake frequency of the vehicle is greater than a brake frequency threshold and the vehicle dose not wait for a traffic light, determining that the vehicle is in the temporary waiting state, otherwise, determining that the vehicle is not in the temporary waiting state.

6. The method according to claim 1, wherein judging whether the vehicle is in the temporary waiting state or not comprises:
judging whether the vehicle is in the temporary waiting state or not according to a current location of the vehicle.

7. The method according to claim 6, wherein judging whether the vehicle is in the temporary waiting state or not according to the current location of the vehicle comprises:
obtaining real-time traffic information corresponding to the current location based on the current location; and
in the case that the current location indicated by the real-time traffic information is a location of waiting for a traffic light, determining a waiting time period needed by the vehicle to wait for the traffic light from a current time, and in the case that the waiting time period is less than a threshold time, determining that the vehicle is in the temporary waiting state, otherwise, determining that the vehicle is not in the temporary waiting state.

8. The method according to claim 3, wherein in the case that the vehicle is not in the temporary waiting state, the method further comprises: turning on the automatic start/stop function of the vehicle.

9. The method according to claim 1, wherein before turning off the automatic start/stop function of the vehicle, the method further comprises:
determining that the automatic start/stop function of the vehicle is turned on or off through an automatic mode rather than a manual mode.

10. An in-vehicle system, comprising: a controller and a processor,
wherein the processor is configured to judge whether the vehicle is in a temporary waiting state or not; and
the controller is configured to turn off an automatic start/stop function of the in-vehicle system in the case that the processor determines that the vehicle is in the temporary waiting state.

11. The in-vehicle system according to claim 10, further comprising a brake information obtaining device configured to obtain a current brake frequency of the vehicle and provide the brake frequency to the processor; and
the processor is configured to determine whether the vehicle is in the temporary waiting state or not at least according to the brake frequency.

12. The in-vehicle system according to claim 11, further comprising a positioning device configured to obtain a current location of the vehicle and provide the current location to the processor; and
the processor is configured to determine whether the vehicle is in the temporary waiting state or not according to the brake frequency and the current location.

13. The in-vehicle system according to claim 10, further comprising a positioning device configured to obtain a current location of the vehicle and provide the current location to the processor; and
the processor is configured to determine whether the vehicle is in the temporary waiting state or not according to the current location.

14. A vehicle control device, comprising:
a judgment unit configured to judge whether a vehicle is in a temporary waiting state or not; and
a control unit configured to turn off an automatic start/stop function of the vehicle in a case that a judgment result is that the vehicle is in the temporary waiting state.

15. The device according to claim 14, wherein the judgment unit is further configured to judge whether the vehicle is in the temporary waiting state or not at least according to a current brake frequency of the vehicle.

16.-18 (canceled)

19. The device according to claim 14, wherein the judgment unit is further configured to judge whether the vehicle is in the temporary waiting state or not according to a current location of the vehicle.

20. (canceled)

21. The device according to claim 16, further comprising: a start unit,
in the case that the vehicle is not in the temporary waiting state, the start unit turns on the automatic start/stop function of the vehicle.

22. (canceled)

23. A vehicle control system, comprising a traffic information system and the in-vehicle system according claim 10, wherein the traffic information system sends traffic information to the in-vehicle system, and the in-vehicle system determines to turn on or off an automatic start/stop function of the vehicle according to the traffic information.

24. The vehicle control system according to claim 23, wherein the in-vehicle system is connected with the traffic information system through a network, and the traffic information system is configured to send the traffic information to the in-vehicle system through the network.

25. The vehicle control system according to claim 24, wherein the network comprises at least one of a wired communication network or a wireless communication network.
